(19) United States
(12) Patent Application Publication
(10) Pub. No.: US 2026/0281916 A1
(43) Pub. Date: Sep. 17, 2026

(54) TRANSMIT POWER CONTROL FOR COORDINATED SPATIAL REUSE IN WIRELESS COMMUNICATIONS

(71) Applicant: MEDIATEK INC., Hsinchu City (TW)

(72) Inventors: You-Wei CHEN, San Jose, CA (US); Jianhan LIU, San Jose, CA (US); Shengquan HU, San Jose, CA (US); Yongho SEOK, San Jose, CA (US); Gary A. ANWYL, San Jose, CA (US); Thomas Edward PARE, Jr., San Jose, CA (US)

(21) Appl. No.: 19/167,709

(22) PCT Filed: Jul. 11, 2024
(86) PCT No.: PCT/CN2024/104869

§ 371 Date: Sep. 22, 2025

Related U.S. Application Data
(60) Provisional application No. 63/512,915, filed on Jul. 11, 2023.

(51) Int. Cl. H04W 52/34; H04W 52/24

(52) U.S. Cl. CPC H04W 52/346; H04W 52/241; H04W 52/242

(57) ABSTRACT

Techniques pertaining to transmit power control for coordinated spatial reuse (CSR) in wireless communications are described. A sharing access point (AP) obtains a transmission opportunity (TXOP) to participate in a coordinated spatial reuse (CSR) operation with one or more shared APs regarding communications one or more non-AP stations (STAs) associated with the sharing AP. The sharing AP controls a transmit (Tx) power of at least a first shared AP of the one or more shared APs in the CSR operation within the TXOP.

### CROSS REFERENCE TO RELATED PATENT APPLICATION(S)

The present disclosure is part of a non-provisional patent application claiming the priority benefit of U.S. Provisional Patent Application No. 63/512,915, filed 11 Jul. 2023, the content of which herein being incorporated by reference in its entirety.

### TECHNICAL FIELD

The present disclosure is generally related to wireless communications and, more particularly, to transmit power control for coordinated spatial reuse (CSR) in wireless communications.

### BACKGROUND

Unless otherwise indicated herein, approaches described in this section are not prior art to the claims listed below and are not admitted as prior art by inclusion in this section.

In wireless communications, such as Wi-Fi (or WiFi) and wireless local area network (WLAN) based on one or more Institute of Electrical and Electronics Engineers (IEEE) 802.11 standards, CSR can enhance the throughput of a multiple-access point (multi-AP) system. CSR is different from overlapping basic service set-power detection (OBSS-PD) based spatial reuse defined in IEEE 802.11ax because CSR relies on coordination among multiple APs. In CSR, an AP, herein referred to as a sharing AP, gains a transmission opportunity (TXOP) and coordinates other APs, herein referred to as shared AP, to participate in spatial reuse within the TXOP. The sharing AP may conduct a single-user (SU) or multi-user (MU) transmission, and each associated non-AP station (STA) may obtain different signal-to-interference-and-noise ratio (SINR) from the shared AP(s). However, how to control the transmit power in CSR remains to be defined at the time of the present invention. Therefore, there is a need for a solution of transmit power control for CSR in wireless communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to provide schemes, concepts, designs, techniques, methods and apparatuses pertaining transmit power control for CSR in wireless communications. It is believed that, under various proposed schemes in accordance with the present disclosure, the aforementioned issue(s) may be addressed or otherwise alleviated. Under the various proposed schemes, transmit power signaling may contain certain information such as, for example: (1) direct transmit power or power limit per shared AP; (2) direct transmit power(s) or power limit(s) for different resource units (RUs) or multi-RUs (MRUs) per shared AP; (3) direct transmit power(s) or power limit(s) for predefined subchannels per shared AP; (4) direct transmit power(s) or power limit(s) for selected subchannels per shared AP; and (5) direct transmit power(s) or power limit(s) for selected CSR durations per shared AP. Herein, the term “direct transmit power” (or “direct Tx power”) refers to a power level, as directly indicated by the sharing AP to a shared AP, at which the shared AP is to perform transmission (e.g., transmission of one or more physical-layer protocol data units (PPDUs)).

In one aspect, a method may involve a processor of a sharing AP obtaining a TXOP to participate in a CSR operation with one or more shared APs regarding communications one or more non-AP STAs associated with the sharing AP. The method may also involve the processor controlling a transmit power of at least a first shared AP of the one or more shared APs in the CSR operation within the TXOP.

In one aspect, a method may involve a processor of a shared AP participating in a CSR operation with a sharing AP regarding communications with one or more non-AP STAs associated with the sharing AP. The method may also involve the processor receiving a Tx power signaling from the sharing AP that controls a Tx power of the shared AP in the CSR operation within a TXOP.

It is noteworthy that, although description provided herein may be in the context of certain radio access technologies, networks and network topologies such as, Wi-Fi, the proposed concepts, schemes and any variation(s)/derivative(s) thereof may be implemented in, for and by other types of radio access technologies, networks and network topologies such as, for example and without limitation, WiMax, Bluetooth, ZigBee, 5th Generation (5G)/New Radio (NR), Long-Term Evolution (LTE), LTE-Advanced, LTE-Advanced Pro, Internet-of-Things (IoT), Industrial IoT (IIoT) and narrowband IoT (NB-IoT). Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation to clearly illustrate the concept of the present disclosure.

FIG. 1 is a diagram of an example network environment in which various solutions and schemes in accordance with the present disclosure may be implemented.

FIG. 2 is a diagram of an example scenario in accordance with the present disclosure.

FIG. 3 is a diagram of an example scenario in accordance with the present disclosure.

FIG. 4 is a diagram of an example scenario in accordance with the present disclosure.

FIG. 5 is a diagram of an example scenario in accordance with the present disclosure.

FIG. 6 is a diagram of an example scenario in accordance with the present disclosure.

FIG. 7 is a diagram of an example scenario in accordance with the present disclosure.

FIG. 8 is a diagram of an example scenario in accordance with the present disclosure.

FIG. 9 is a diagram of an example scenario in accordance with the present disclosure.

FIG. 10 is a diagram of an example scenario in accordance with the present disclosure.

FIG. 11 is a diagram of an example scenario in accordance with the present disclosure.

FIG. 12 is a diagram of an example scenario in accordance with the present disclosure.

FIG. 13 is a diagram of an example scenario in accordance with the present disclosure.

FIG. 14 is a block diagram of an example communication system in accordance with an implementation of the present disclosure.

FIG. 15 is a flowchart of an example process in accordance with an implementation of the present disclosure.

FIG. 16 is a flowchart of an example process in accordance with an implementation of the present disclosure.

### DETAILED DESCRIPTION OF PREFERRED EMBODIMENTS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to transmit power control for CSR in wireless communications. According to the present disclosure, a number of possible solutions may be implemented separately or jointly. That is, although these possible solutions may be described below separately, two or more of these possible solutions may be implemented in one combination or another.

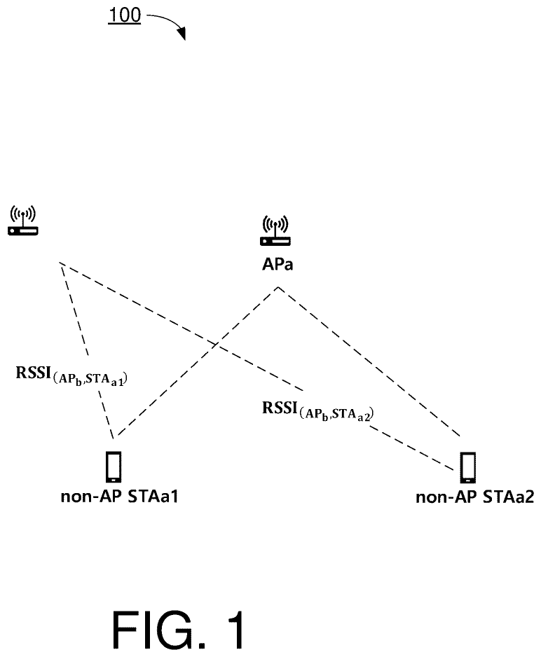

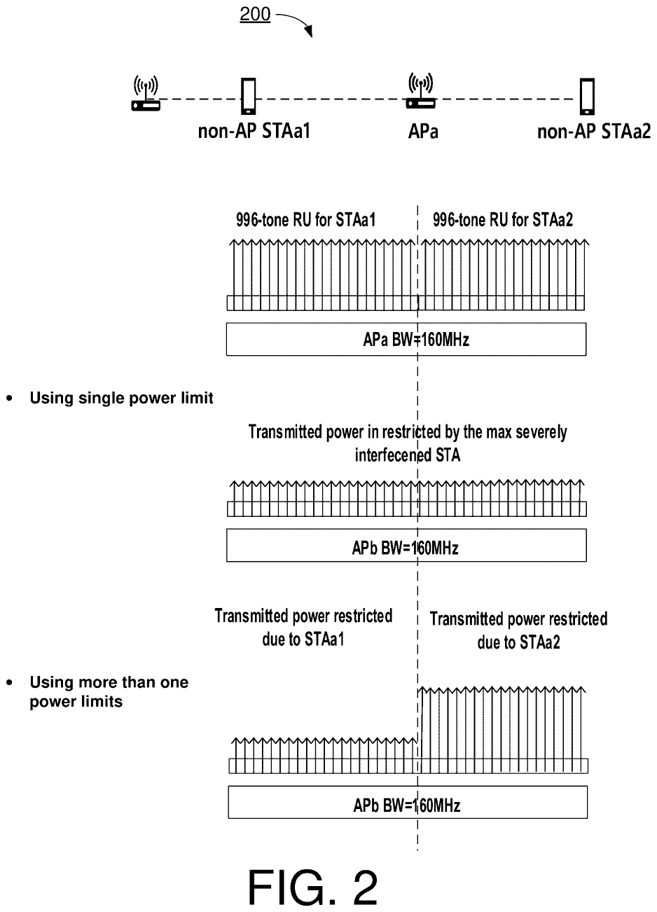

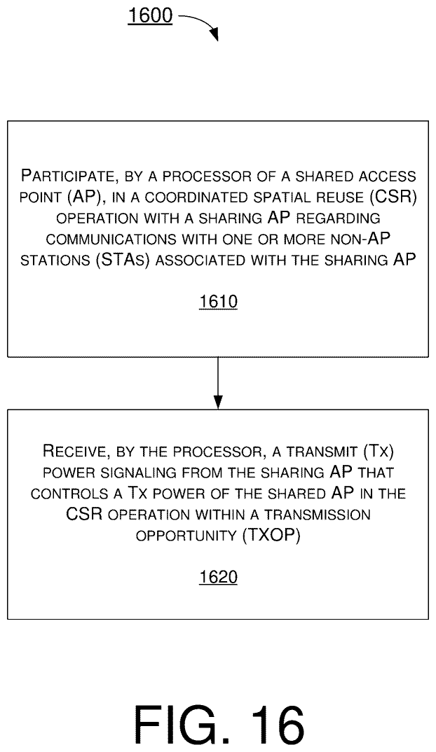

FIG. 1 illustrates an example network environment 100 in which various solutions and schemes in accordance with the present disclosure may be implemented. FIG. 2~FIG. 16 illustrate examples of implementation of various proposed schemes in network environment 100 in accordance with the present disclosure. The following description of various proposed schemes is provided with reference to FIG. 1~FIG. 16.

Referring to FIG. 1, network environment 100 may involve a plurality of APs (e.g., APa and APb) as well as a plurality of non-AP STAs (e.g., STAa1 and STAa2). APa and APb may form or otherwise establish a multi-AP (MAP) configuration such that one of APa and APb may be a sharing AP while the other may be a shared AP. For instance, APa may function as a sharing AP, and APb may function as a shared AP. Each of APa and APb may be configured to perform transmit power control for CSR in wireless communications under various proposed schemes as described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

Referring to FIG. 1, non-AP STAs associated with the sharing AP (e.g., APa) may see different SINRs from the shared AP (e.g., APb). The SINR is related to the transmit (Tx) power of the sharing AP and shared AP. Moreover, the SINR is also related to path loss of the sharing AP and shared AP. For example, the SINRs experienced by non-AP STAa1 associated with the sharing AP and non-AP STAa2 associated with the sharing AP are shown in FIG. 1. For instance, non-AP STAa1 associated with APa, the sharing AP, may experience an SINR=(TxPower_{AP}_{ₐ}−RSSI_{(AP}_{ₐ}_{, STA}_{ₐ₁}₎)−(TxPower_{AP}_{_{b}}−RSSI_{(AP}_{_{b}}_{, STA}_{ₐ₁}₎), with (TxPower_{AP}_{ₐ}−RSSI_{(AP}_{ₐ}_{, STA}_{ₐ₁}₎) representing a signal strength from the sharing AP and (TxPower_{AP}_{_{b}}−RSSI_{(AP}_{_{b}}, _{STA}_{ₐ₁}₎) representing an interference from the shared AP. Moreover, non-AP STAa2 associated with APa, the sharing AP, may experience an SINR=(TxPower_{AP}_{ₐ}−RSSI_{(AP}_{ₐ}_{, STA}_{ₐ₂}₎)−(TxPower_{AP}_{_{b}}−RSSI_{(AP}_{_{b}}_{, STA}_{ₐ₂}₎), with (TxPower_{AP}_{ₐ}−RSSI_{(AP}_{ₐ}_{, STA}_{ₐ₂}₎) representing a signal strength from the sharing AP and (TxPower_{AP}_{_{b}}−RSSI_{(AP}_{_{b}}_{, STA}_{ₐ₂}₎) representing an interference from the shared AP. In this simplified example, since the path loss from APb to non-AP STAa2 is larger than the path loss from APb to non-AP STAa1, the SINR of non-AP STAa2 tends to be higher than that of non-AP STAa1.

FIG. 2 illustrates an example scenario 200 under a proposed scheme in accordance with the present disclosure. Referring to FIG. 2, each non-AP STA (e.g., STAa1 and STAa2) in a sharing basic service set (BSS) may have different bandwidth (BW) or may operate in a different RU or MRU with a different distance related to the sharing AP and shared AP. In the example shown in FIG. 2, the sharing AP, APa, may communicate with STAa1 and STAa2 in a 160 MHz bandwidth by using a 996-tone RU for STAa1 in a lower 80 MHz of the 160 MHz bandwidth and another 996-tone RU for STAa2 in an upper 80 MHz of the 160 MHz bandwidth. In an event that the maximum level of transmit power is limited or otherwise restricted by the most severely interference STA, a single power limit may be used for the Tx power. Alternatively, more than one power limits may be utilized in that the Tx power may be limited or otherwise restricted by each STA of multiple STAs. Under the proposed scheme, the sharing AP may send a transmit power control signaling that contains different transmit power levels or different transmit power limits of different RUs or MRUs or different CSR durations per shared AP. For instance, the transmit power signaling may indicate one or more of the following: (1) direct Tx power level; (2) indexes of RUs or MRUs; (3) equally split among PPDU BW; (4) bitmap; (5) CSR domain, if transmitting to STAs one by one. The minimum granularity of transmission may be 20 MHz.

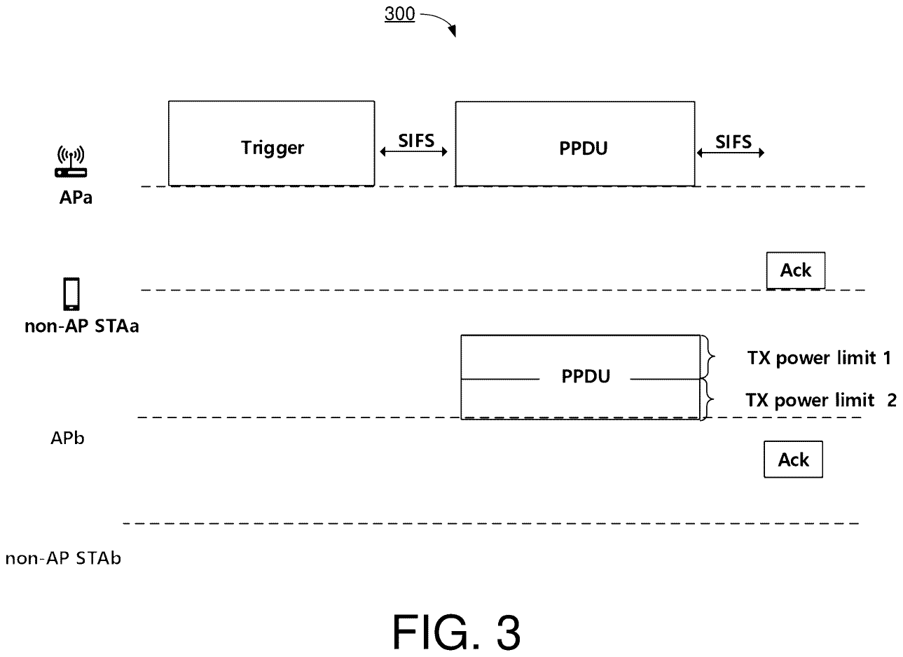

FIG. 3 illustrates an example scenario 300 under a proposed scheme in accordance with the present disclosure. Scenario 300 may pertain to signaling in CSR trigger. Referring to FIG. 3, Tx power limits may be carried by or otherwise indicated in a trigger frame for CSR, which may specify the respective Tx power limit of each shared AP. For instance, the sharing AP, APa, may first transmit a trigger frame and then, after a short interframe spacing (SIFS), transmit a PPDU to one or more of its associated STAs (e.g., non-AP STAa). The shared AP, APb, after receiving the trigger frame from the sharing AP, may transmit a PPDU to one or more of its associated STAs (e.g., non-AP STAb). The shared AP may transmit the PPDU with Tx power limit 1 and Tx power limit 2, corresponding to non-AP STAa and STAb, respectively. The trigger frame may carry or otherwise indicate certain information including, for example and without limitation, a shared AP identifier (ID), downlink (DL)/uplink (UL), bandwidth, Tx power of the sharing AP, TXOP duration, direct Tx power or power limit of the shared AP, number (or quantity) of shared AP(s), number of RU or MRU index(es), RU or MRU index(es), bitmap, CSR duration, and so on.

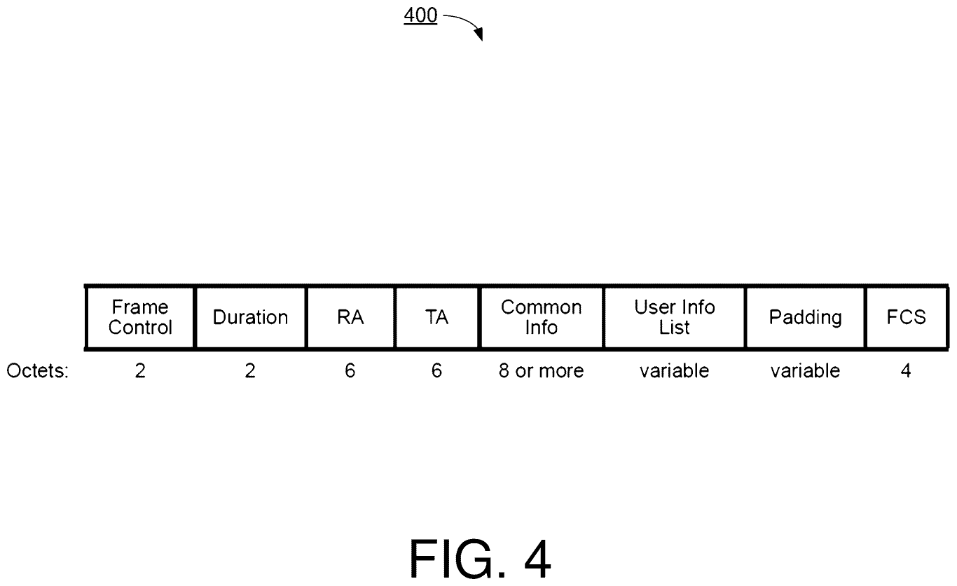

FIG. 4 illustrates an example scenario 400 under a proposed scheme in accordance with the present disclosure. Scenario 400 may pertain to trigger frame format. Under the proposed scheme, trigger frames may be used by the sharing AP to inform the shared AP(s) to set Tx power limits and to allocate resources. The sharing AP may indicate the trigger frame type and the number (or quantity) of shared AP(s) in a Common Info field of the trigger frame. Referring to FIG. 4, which shows a proposed trigger frame format, the trigger frame for CSR may: (1) use the shared AP identifier as the recipient address (RA), if the trigger frame is targeted for one shared AP; or (2) use the broadcast address as RA and include the shared AP identifier in the User Info field. Moreover, the User Info field in the trigger frame for CSR may indicate, among other information, the shared AP identifier(s), direct Tx power or power limit of shared AP(s), number of RU or MRU index(es), RU or MRU index(es), bitmap, and CSR duration. Additionally, the Common Infor field in the trigger frame for CSR may indicate, among other information, trigger frame type, bandwidth, DL/UL, Tx power of shared AP(s), and number (or quantity) of shared AP(s).

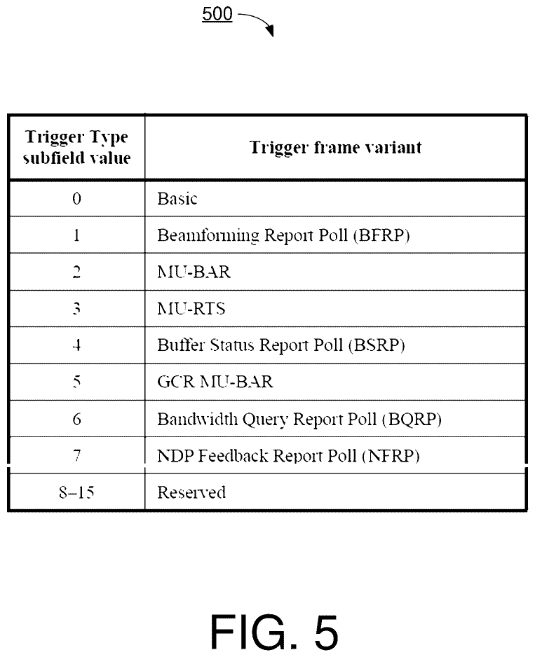

FIG. 5 illustrates an example scenario 500 under a proposed scheme in accordance with the present disclosure. Scenario 500 may pertain to trigger frame type for CSR. Under the proposed scheme, each of the trigger frames sent from/by a sharing AP may be a new type of trigger frame and may use a reserved value in “Trigger Type subfield encoding” table to indicate the trigger frame for CSR, as shown in FIG. 5. Alternatively, each of the trigger frames sent from/by the sharing AP may be a variation of the existing new type of trigger frame. For instance, MAP transmission may be triggered by a multi-user request-to-send (MU-RTS) with additional information.

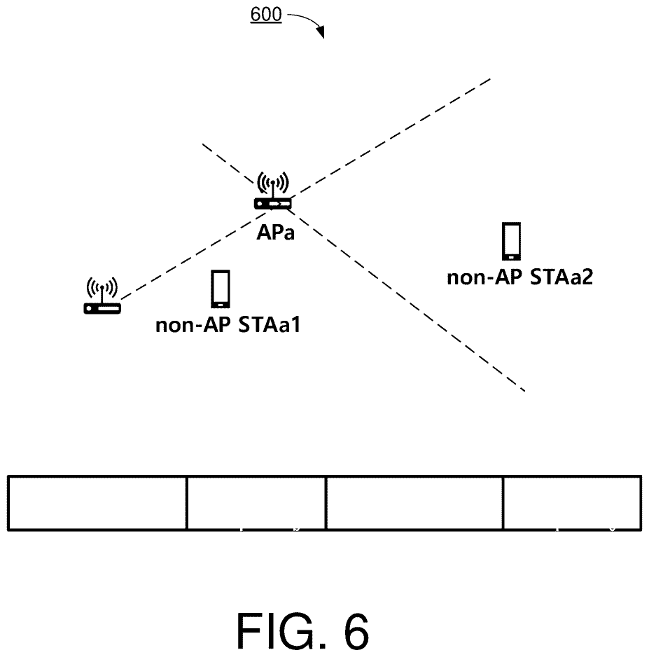

FIG. 6 illustrates an example scenario 600 under a proposed scheme in accordance with the present disclosure. Scenario 600 may pertain to direct Tx power (power limit) per shared AP. Under the proposed scheme, the sharing AP may set one Tx power limit (or direct Tx power level) to the shared AP based on its STA scheduling to minimize interference from the shared AP. For instance, referring to FIG. 6, the Tx power limit (or direct Tx power level) of the shared AP, APb, may be based on the interference level of non-AP STAa1 from APb.

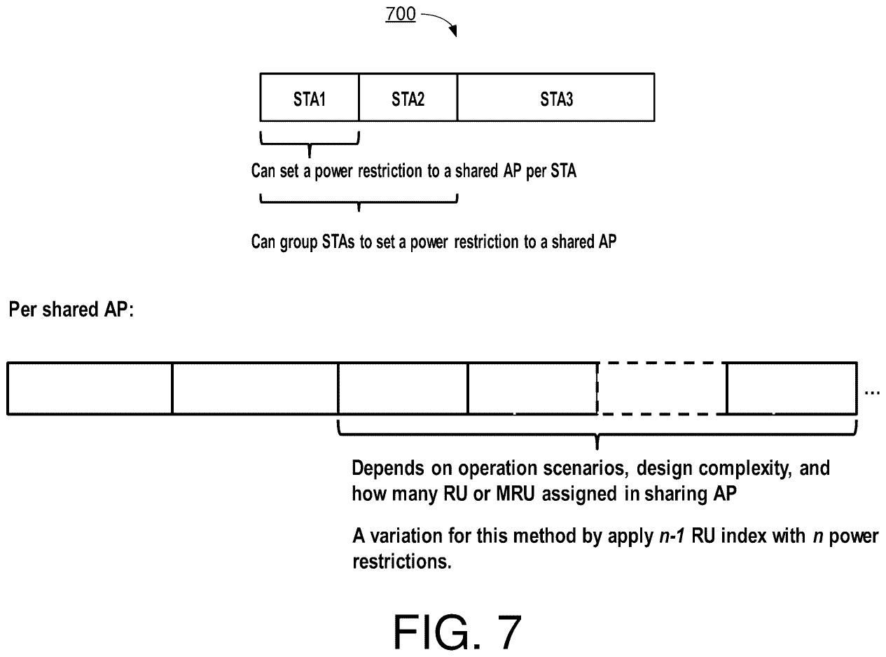

FIG. 7 illustrates an example scenario 700 under a proposed scheme in accordance with the present disclosure. Scenario 700 may pertain to RU or MRU-based power control. Under the proposed scheme, a sharing AP may set the Tx power limit (or direct Tx power level) to a shared AP based on its STA scheduling. The sharing AP may assign different power limits per STA or per grouped STA-based RU(s) or MRU(s). The number of RU or MUR index(es) may be indicated before starting specific power limits. A variation of this proposed scheme may be using n-1 RU or MRU index for all STA RU locations, and the last one STA RU location may be assumed as the bandwidth minus the sum of other indicated RU(s). Referring to FIG. 7, the sharing AP may set or restrict the power limit of a shared AP per STA. Moreover, the sharing AP may group multiple STAs to set a power restriction or limit to a shared AP with respect to the grouped STAs. The number of RUs/MURs and respective maximum power limits may depend on the operation scenarios, design complexity, and how many RUs or MURs assigned in the sharing AP.

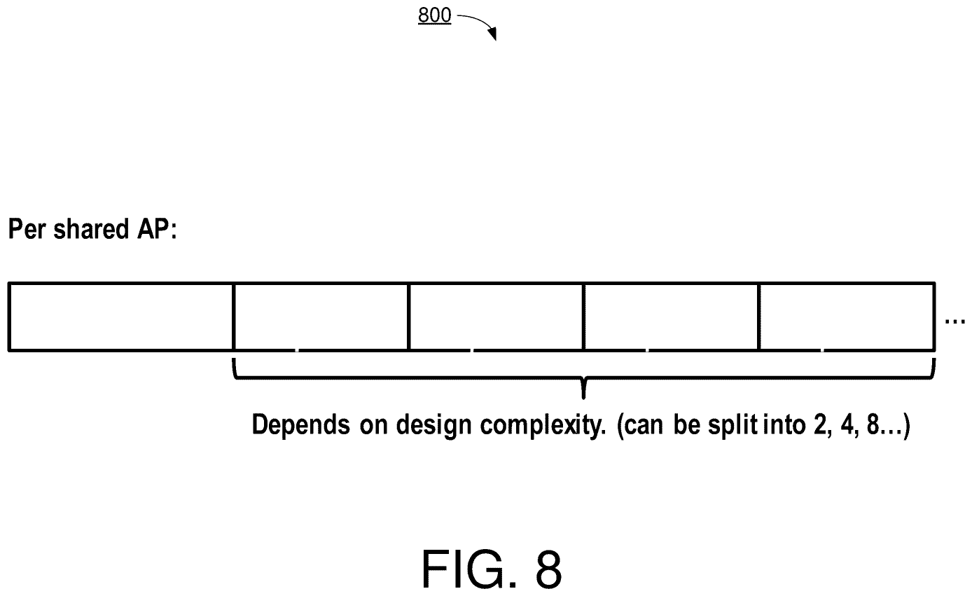

FIG. 8 illustrates an example scenario 800 under a proposed scheme in accordance with the present disclosure. Scenario 800 may pertain to equally splitting of a PPDU BW. Similar to IEEE 802.11ax parameterized spatial reuse (PSR), the PPDU BW may be equally split under the proposed scheme, and corresponding power limits (or direct Tx power levels) may be assigned. The number of power limits (or direct Tx power levels) may be predetermined based on the Tx bandwidth. Under this proposed scheme, the signaling may be simplified by skipping the indicator of the number of RUs or MRUs as well as the RU or MRU indexes (introduced in the proposed scheme described above in example scenario 700). For instance, in case that the sharing AP only allows two different power limits and the bandwidth is indicated as 160 MHz, then each field may apply to 20 MHz subchannel of the lowest and highest 80 MHz, respectively, in the frequency domain.

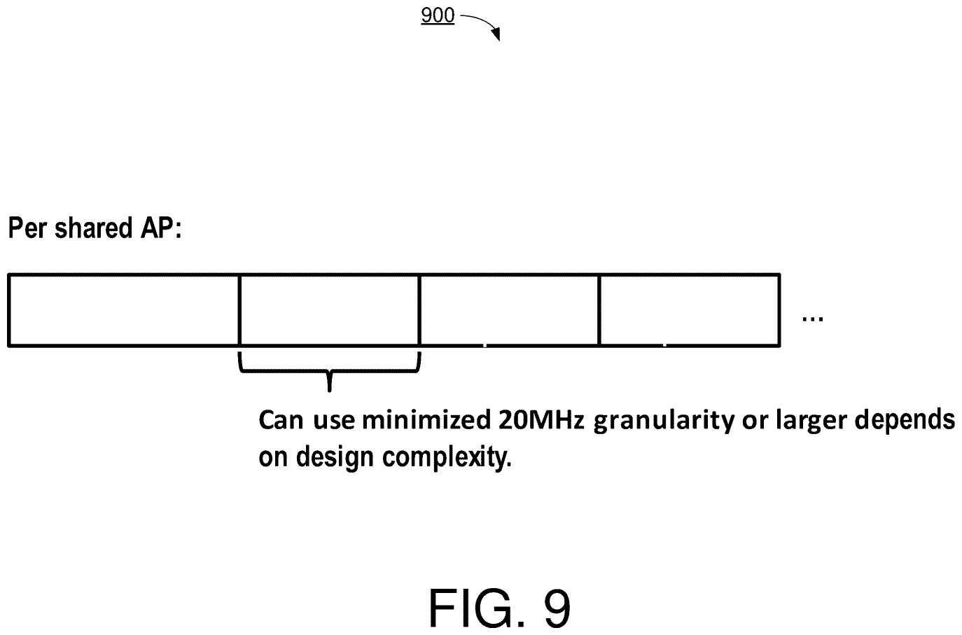

FIG. 9 illustrates an example scenario 900 under a proposed scheme in accordance with the present disclosure. Scenario 900 may pertain to using a bitmap for Tx power control. Under the proposed scheme, the sharing AP may set the Tx power limits (or direct Tx power levels) to the shared AP(s) by using a bitmap, with each bit of the bitmap indicating a respective Tx power limit or direct Tx power level corresponding to a respective frequency segment or subchannel of an operating bandwidth (e.g., PPDU BW). This may provide additional flexibility in the frequency domain. For instance, in case that the sharing AP allows two different power limits and the operating channel spans across a Federal Communications Commission (FCC) boundary (e.g., 6 GHz Low Power Indoor (LPI) and standard power (SP) modes), then the sharing AP may indicate a 20 MHz-granularity bitmap with different Tx power limits to the shared AP(s).

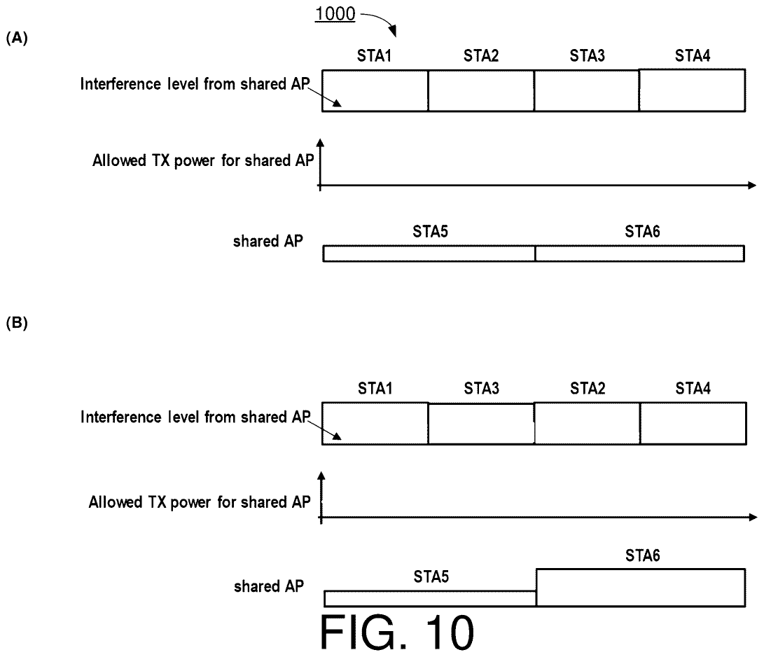

FIG. 10 illustrates an example scenario 1000 under a proposed scheme in accordance with the present disclosure. Scenario 1000 may pertain to STA scheduling by the sharing AP. Under the proposed scheme, with respect to providing multiple Tx power limits (or direct Tx power levels) to the shared AP(s), the sharing AP may schedule its associated STA(s) depending on its/their corresponding received signal strength indicator (RSSI) or path loss information respective to the shared AP(s). For instance, the higher interference from a given shared AP as experienced by a certain STA, the lower the respective Tx power limit (or direct Tx power level) the sharing AP may set for the shared AP with respect to that certain STA, and vice versa, as shown in FIG. 10. In case that the sharing AP schedules available recourse in an ascending (or descending) order regarding RSSI information, the shared AP(s) may gain more flexibility to schedule its own STAs. For instance, referring to FIG. 10, in some situation a most restrictive Tx power limit may be followed by a shared AP when there are two STAs (e.g., STA5 and STA6) associated with the shared AP, as shown in part (A) of FIG. 10. On the other hand, under the proposed scheme, with more flexibility the shared AP may allocate more power to STA6, as shown in part (B) of FIG. 10.

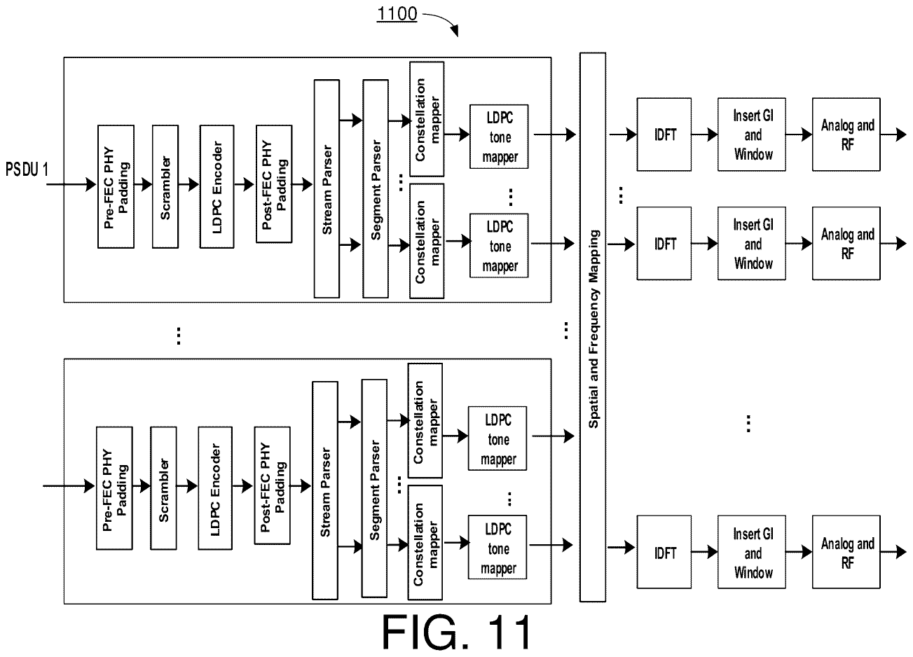

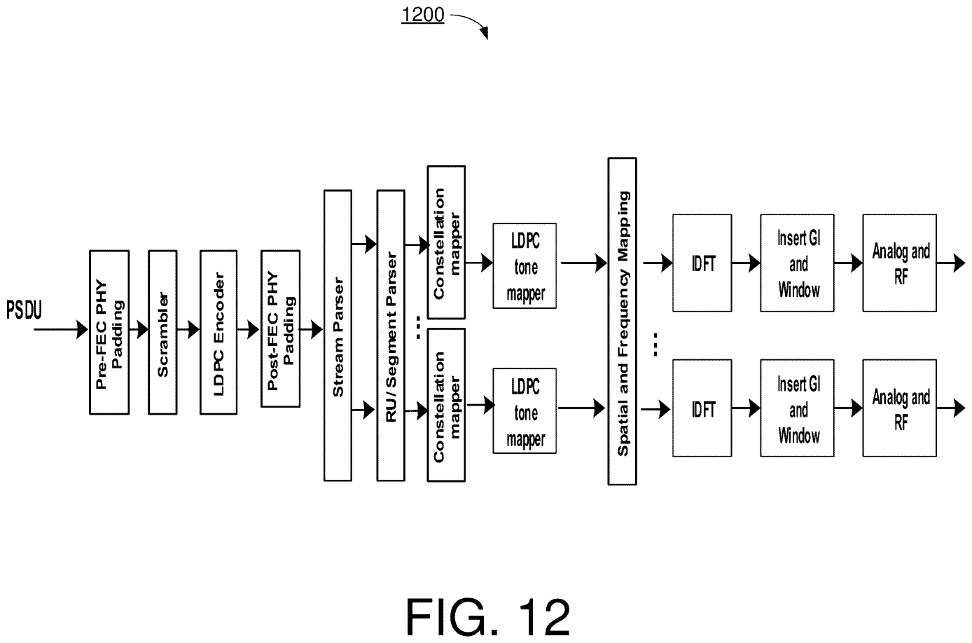

FIG. 11 illustrates an example scenario 1100 under a proposed scheme in accordance with the present disclosure. FIG. 12 illustrates an example scenario 1200 under a proposed scheme in accordance with the present disclosure. Each of scenario 1100 and scenario 1200 may pertain to an implementation option in case of multiple Tx power limitation in frequency domain. Specifically, scenario 1100 may pertain to an independent encoding implementation, and scenario 1200 may pertain to a joint encoding implementation. Under the proposed scheme, in an orthogonal frequency-division multiple-access (OFDMA) operation, multiple encoders may be used and, in single-user (SU) transmissions, unequal power, quadrature amplitude modulation (QAM) and modulation and coding scheme (MCS) transmission may be performed with one or more of several options. A first option may involve boosting power spectral density (PSD) and remaining the same MCS. A second option may involve boosting the PSD and performing coding with independent encoding schemes with MCS level boosting. A third option may involve boosting the PSD and performing coding with joint encoding schemes with QAM level boosting.

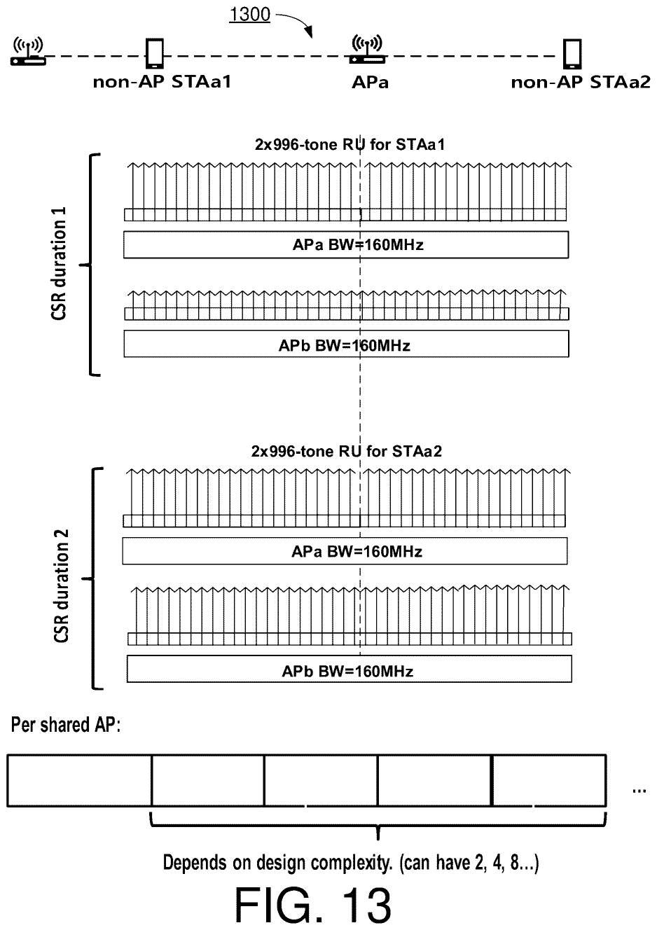

FIG. 13 illustrates an example scenario 1300 under a proposed scheme in accordance with the present disclosure. Scenario 1300 may pertain to multiple Tx power control in time domain. Under the proposed scheme, during a CSR operation, the sharing AP may perform MU or SU transmission, and the sharing AP may transmit to multiple STAs within a TXOP one by one. More specifically, the sharing AP may indicate multiple Tx power limits and duration information to the shared AP(s). Under the proposed scheme, a CSR duration indicator may be utilized to indicate a time duration or Tx start time. For instance, a non-AP STAa1 may suffer more interference from APb and thus, in CSR duration1, non-AP STAa1 may apply for a more restrictive Tx power limitation. Meanwhile, as the sharing AP communicates with anon-AP STAa2, the power limit of the shared AP may be relaxed in CSR duration2.

### Illustrative Implementations

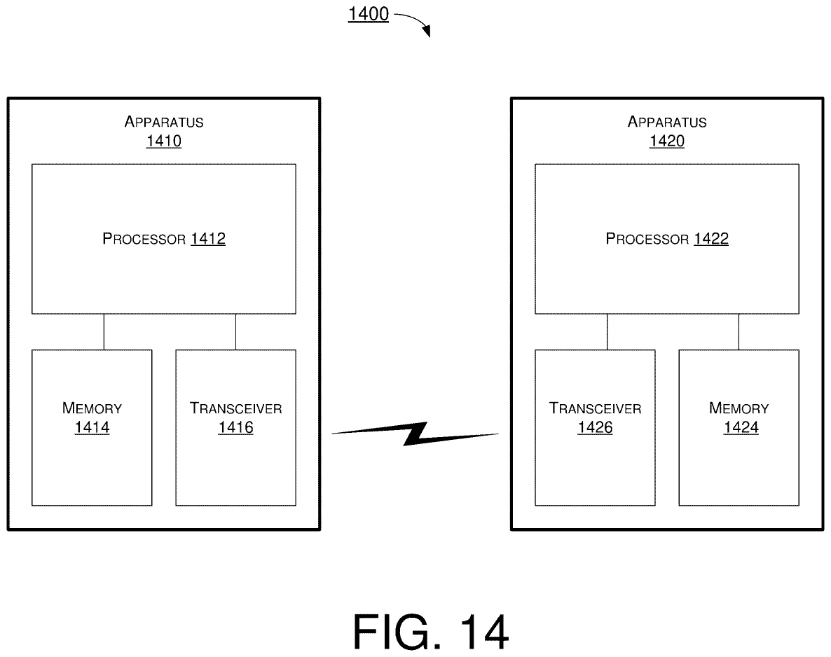

FIG. 14 illustrates an example system 1400 having at least an example apparatus 1410 and an example apparatus 1420 in accordance with an implementation of the present disclosure. One or each of apparatus 1410 and apparatus 1420 may perform various functions to implement schemes, techniques, processes and methods described herein pertaining to transmit power control for CSR in wireless communications, including the various schemes described above with respect to various proposed designs, concepts, schemes, systems and methods described above as well as processes described below. For instance, apparatus 1410 may be implemented in a sharing AP and apparatus 1420 may be implemented in a shared AP, or vice versa.

Each of apparatus 1410 and apparatus 1420 may be a part of an electronic apparatus, which may be a non-AP MLD or an AP MLD, such as a portable or mobile apparatus, a wearable apparatus, a wireless communication apparatus or a computing apparatus. When implemented in a non-AP MLD, each of apparatus 1410 and apparatus 1420 may be implemented in a smartphone, a smart watch, a personal digital assistant, a digital camera, or a computing equipment such as a tablet computer, a laptop computer or a notebook computer. Each of apparatus 1410 and apparatus 1420 may also be a part of a machine type apparatus, which may be an IoT apparatus such as an immobile or a stationary apparatus, a home apparatus, a wire communication apparatus or a computing apparatus. For instance, each of apparatus 1410 and apparatus 1420 may be implemented in a smart thermostat, a smart fridge, a smart door lock, a wireless speaker or a home control center. When implemented in or as a network apparatus, apparatus 1410 and/or apparatus 1420 may be implemented in a network node, such as an AP (e.g., sharing AP or shared AP).

In some implementations, each of apparatus 1410 and apparatus 1420 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. In the various schemes described above, each of apparatus 1410 and apparatus 1420 may be implemented in or as a sharing AP or shared AP. Each of apparatus 1410 and apparatus 1420 may include at least some of those components shown in FIG. 14 such as a processor 1412 and a processor 1422, respectively, for example. Each of apparatus 1410 and apparatus 1420 may further include one or more other components not pertinent to the proposed scheme of the present disclosure (e.g., internal power supply, display device and/or user interface device), and, thus, such component(s) of apparatus 1410 and apparatus 1420 are neither shown in FIG. 14 nor described below in the interest of simplicity and brevity.

In one aspect, processor 1412 and processor 1422 may be implemented in the form of one or more single-core processors, one or more multi-core processors, one or more RISC processors or one or more CISC processors. That is, even though a singular term “a processor” is used herein to refer to processor 1412 and processor 1422, processor 1412 and processor 1422 may include multiple processors in some implementations and a single processor in other implementations in accordance with the present disclosure. In another aspect, processor 1412 and processor 1422 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, processor 1412 and processor 1422 is a special-purpose machine specifically designed, arranged and configured to perform specific tasks including those pertaining to transmit power control for CSR in wireless communications in accordance with various implementations of the present disclosure.

In some implementations, apparatus 1410 may also include one or more transceivers 1416 coupled to processor 1412. Each of the one or more transceivers 1416 may include a transmitter capable of wirelessly transmitting and a receiver capable of wirelessly receiving data. In some implementations, apparatus 1420 may also include one or more transceivers 1426 coupled to processor 1422. Each of the one or more transceivers 1426 may include a transmitter capable of wirelessly transmitting and a receiver capable of wirelessly receiving data. It is noteworthy that, although only one transceiver 1416/1426 is shown in FIG. 14, in some implementations, apparatus 1410 and/or apparatus 1420 may be equipped with multiple transceivers 1416 or multiple transceivers 1426.

In some implementations, apparatus 1410 may further include a memory 1414 coupled to processor 1412 and capable of being accessed by processor 1412 and storing data therein. In some implementations, apparatus 1420 may further include a memory 1424 coupled to processor 1422 and capable of being accessed by processor 1422 and storing data therein. Each of memory 1414 and memory 1424 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 1414 and memory 1424 may include a type of read-only memory (ROM) such as mask ROM, programmable ROM (PROM), erasable programmable ROM (EPROM) and/or electrically erasable programmable ROM (EEPROM). Alternatively, or additionally, each of memory 1414 and memory 1424 may include a type of non-volatile random-access memory (NVRAM) such as flash memory, solid-state memory, ferroelectric RAM (FeRAM), magnetoresistive RAM (MRAM) and/or phase-change memory.

Each of apparatus 1410 and apparatus 1420 may be a communication entity capable of communicating with each other using various proposed schemes in accordance with the present disclosure. For illustrative purposes and without limitation, a description of capabilities of apparatus 1410, as a sharing AP, and apparatus 1420, as a shared AP, is provided below in the context of example processes 1500 and 1600. It is noteworthy that, although the example implementations described below are provided in the context of WLAN, the same may be implemented in other types of networks. It is also noteworthy that, although examples described below are provided in the context of apparatus 1410, the examples may also be applicable to apparatus 1420 or otherwise implemented by apparatus 1420.

### Illustrative Processes

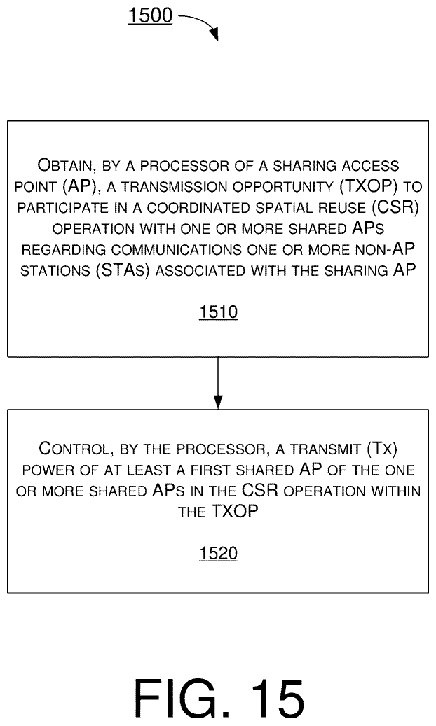

FIG. 15 illustrates an example process 1500 in accordance with an implementation of the present disclosure. Process 1500 may represent an aspect of implementing various proposed designs, concepts, schemes, systems and methods described above. More specifically, process 1500 may represent an aspect of the proposed concepts and schemes pertaining to transmit power control for CSR in wireless communications in accordance with the present disclosure. Process 1500 may include one or more operations, actions, or functions as illustrated by one or more blocks. Although illustrated as discrete blocks, various blocks of process 1500 may be divided into additional blocks, combined into fewer blocks, or eliminated, depending on the desired implementation. Moreover, the blocks/sub-blocks of process 1500 may be executed in the order shown in FIG. 15 or, alternatively, in a different order. Furthermore, one or more of the blocks/sub-blocks of process 1500 may be executed repeatedly or iteratively. Process 1500 may be implemented by or in apparatus 1410 and apparatus 1420 as well as any variations thereof. Solely for illustrative purposes and without limiting the scope, process 1500 is described below in the context of apparatus 1410 implemented in or a sharing AP (e.g., APa) and apparatus 1420 implemented in or as a shared AP (e.g., APb) of a wireless network such as a WLAN in network environment 100 in accordance with one or more of IEEE 802.11 standards. Process 1500 may begin at block 1510.

At 1510, process 1500 may involve processor 1412 of apparatus 1410 (as a sharing AP) obtaining, via transceiver 1416, a TXOP to participate in a CSR operation with one or more shared APs regarding communications one or more non-AP STAs associated with the sharing AP. Process 1500 may proceed from 1510 to 1520.

At 1520, process 1500 may involve processor 1412 controlling, via transceiver 1416, a Tx power of at least a first shared AP (e.g., apparatus 1420) of the one or more shared APs in the CSR operation within the TXOP.

In some implementations, in controlling the Tx power of at least the first shared AP of the one or more shared APs, process 1500 may involve processor 1412 controlling at least one of: (a) a direct Tx power level or a Tx power limit per shared AP; (b) a direct Tx power level or a Tx power limit for different RUs or MRUs per shared AP; (c) a direct Tx power level or a Tx power limit for predefined or selected subchannels per shared AP; and (d) a direct Tx power level or a Tx power limit for a selected CSR duration per shared AP.

In some implementations, in controlling the Tx power of the first shared AP, process 1500 may involve processor 1412 transmitting a Tx power signaling that indicates an ID of the first shared AP and information associated to control of a Tx power of the first shared AP. In some implementations, the information associated to control of a Tx power of the first shared AP may include one or more of the following: (i) a direct Tx power level or a Tx power limit of the first shared AP; (ii) a quantity of the one or more shared APs; (iii) a number of RUs or MRUs; (iv) an RU or MRU index; (v) a bitmap; and (vi) a CSR duration.

In some implementations, the Tx power signaling may include a trigger frame used by the sharing AP to control the Tx power of at least the first shared AP and allocate resources. In some implementations, the trigger frame may indicate either: (a) an ID of the first shared AP as an RA; or (b) a broadcast address as the RA while the ID of the first shared AP is indicated in a User Info field of the trigger frame. In some implementations, a Common Info field of the trigger frame may indicate the quantity of the one or more shared APs and a trigger frame type indicating the trigger frame being used for the CSR operation. Moreover, a User Infor field of the trigger frame may indicate one or more of the direct Tx power level or a Tx power limit of the first shared AP, the number of RUs or MRUs, the RU or MRU index, the bitmap and the CSR duration. In some implementations, the trigger frame may include either: (a) a new type of trigger frame that uses a reserved value in a Trigger Type subfield encoding table to indicate that the trigger frame is used for the CSR operation; or (b) a variation of an existing type of trigger frame.

In some implementations, in controlling the Tx power of at least the first shared AP of the one or more shared APs, process 1500 may involve processor 1412 setting a Tx power limit or a direct Tx power level of each of the one or more shared AP based on scheduling of the one or more non-AP STAs.

In some implementations, in controlling the Tx power of at least the first shared AP of the one or more shared APs, process 1500 may involve processor 1412 assigning different power limits to at least the first shared AP per STA of the one or more non-AP STAs or per group of STAs based on one or more RUs or MRUs corresponding to the one or more non-AP STAs. In some implementations, in controlling the Tx power of at least the first shared AP of the one or more shared APs, process 1500 may further involve processor 1412 transmitting a trigger frame that indicates an ID of the first shared AP, a number of RU or MRU indexes and, for each of the one or more RUs or MRUs, a respective RU or MRU index and a respective maximum Tx power. In some implementations, in assigning the different power limits to at least the first shared AP, process 1500 may involve processor 1412 performing certain operations. For instance, process 1500 may involve processor 1412 splitting a PPDU bandwidth into a plurality of segments by a number of the different power limits. Moreover, process 1500 may involve processor 1412 assigning each of the different power limits to a respective segment of the plurality of segments.

In some implementations, in controlling the Tx power of at least the first shared AP of the one or more shared APs, process 1500 may involve processor 1412 providing a bitmap with each bit of the bitmap indicating a respective Tx power limit or direct Tx power level corresponding to a respective frequency segment or subchannel of an operating bandwidth.

In some implementations, in controlling the Tx power of at least the first shared AP of the one or more shared APs, process 1500 may involve processor 1412 scheduling each of the one or more non-AP STAs based on a corresponding RSSI or path loss respective to at least the first shared AP.

In some implementations, in controlling the Tx power of at least the first shared AP of the one or more shared APs, process 1500 may involve processor 1412 causing at least the first shared AP to transmit by: (a) boosting a PSD while keeping a same MCS; or (b) boosting the PSD and coding with an independent encoding scheme with MCS boosting; or (c) boosting the PSD and coding with a joint encoding scheme with QAM level boosting.

In some implementations, in controlling the Tx power of at least the first shared AP of the one or more shared APs, process 1500 may involve processor 1412 indicating to at least the first shared AP one or more Tx power limits and one or more CSR durations with each of the one or more Tx power limits corresponding to each of the one or more CSR durations.

FIG. 16 illustrates an example process 1600 in accordance with an implementation of the present disclosure. Process 1600 may represent an aspect of implementing various proposed designs, concepts, schemes, systems and methods described above. More specifically, process 1600 may represent an aspect of the proposed concepts and schemes pertaining to transmit power control for CSR in wireless communications in accordance with the present disclosure. Process 1600 may include one or more operations, actions, or functions as illustrated by one or more blocks. Although illustrated as discrete blocks, various blocks of process 1600 may be divided into additional blocks, combined into fewer blocks, or eliminated, depending on the desired implementation. Moreover, the blocks/sub-blocks of process 1600 may be executed in the order shown in FIG. 16 or, alternatively, in a different order. Furthermore, one or more of the blocks/sub-blocks of process 1600 may be executed repeatedly or iteratively. Process 1600 may be implemented by or in apparatus 1410 and apparatus 1420 as well as any variations thereof. Solely for illustrative purposes and without limiting the scope, process 1600 is described below in the context of apparatus 1410 implemented in or a sharing AP (e.g., APa) and apparatus 1420 implemented in or as a shared AP (e.g., APb) of a wireless network such as a WLAN in network environment 100 in accordance with one or more of IEEE 802.11 standards. Process 1600 may begin at block 1610.

At 1610, process 1600 may involve processor 1422 of apparatus 1420 (as a shared AP) participating, via transceiver 1426, in a CSR operation with a sharing AP (e.g., apparatus 1410) regarding communications with one or more non-AP STAs associated with the sharing AP. Process 1600 may proceed from 1610 to 1620.

At 1620, process 1600 may involve processor 1422 receiving, via transceiver 1426, a Tx power signaling from the sharing AP that controls a Tx power of the shared AP in the CSR operation within a TXOP.

In some implementations, the Tx power signaling may control at least one of the following: (a) a direct Tx power level or a Tx power limit of the shared AP; (b) a direct Tx power level or a Tx power limit for different RUs or MRUs of the shared AP; (c) a direct Tx power level or a Tx power limit for predefined or selected subchannels of the shared AP; and (d) a direct Tx power level or a Tx power limit for a selected CSR duration of the shared AP.

In some implementations, in receiving the Tx power signaling, process 1600 may involve processor 1422 receiving a trigger frame that indicates an ID of the shared AP and information associated to control of a Tx power of the shared AP. In some implementations, the information associated to control of a Tx power of the first shared AP may include one or more of the following: (i) a direct Tx power level or a Tx power limit of the shared AP; (ii) a quantity of the one or more shared APs; (iii) a number of RUs or MRUs; (iv) an RU or MRU index; (v) a bitmap; and (vi) a CSR duration.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
obtaining, by a processor of a sharing access point (AP), a transmission opportunity (TXOP) to participate in a coordinated spatial reuse (CSR) operation with one or more shared APs regarding communications one or more non-AP stations (STAs) associated with the sharing AP; and
controlling, by the processor, a transmit (Tx) power of at least a first shared AP of the one or more shared APs in the CSR operation within the TXOP.

2. The method of claim 1, wherein the controlling of the Tx power of at least the first shared AP of the one or more shared APs comprises controlling at least one of:
a direct Tx power level or a Tx power limit per shared AP;
a direct Tx power level or a Tx power limit for different resource units (RUs) or multi-RUs (MRUs) per shared AP;
a direct Tx power level or a Tx power limit for predefined or selected subchannels per shared AP; and
a direct Tx power level or a Tx power limit for a selected CSR duration per shared AP.

3. The method of claim 1, wherein the controlling of the Tx power of the first shared AP comprises transmitting a Tx power signaling that indicates an identifier (ID) of the first shared AP and information associated to control of a Tx power of the first shared AP.

4. The method of claim 3, wherein the information associated to control of a Tx power of the first shared AP comprises one or more of:
a direct Tx power level or a Tx power limit of the first shared AP;
a quantity of the one or more shared APs;
a number of resource units (RUs) or multi-RUs (MRUs);
an RU or MRU index;
a bitmap; and
a CSR duration.

5. The method of claim 3, wherein the trigger frame indicates:
an identifier (ID) of the first shared AP as a recipient address (RA); or
a broadcast address as the RA while the ID of the first shared AP is indicated in a User Info field of the trigger frame.

6. The method of claim 3, wherein a Common Info field of the trigger frame indicates the quantity of the one or more shared APs and a trigger frame type indicating the trigger frame being used for the CSR operation, and wherein a User Infor field of the trigger frame indicates one or more of the direct Tx power level or a Tx power limit of the first shared AP, the number of RUs or MRUs, the RU or MRU index, the bitmap and the CSR duration.

7. The method of claim 6, wherein the trigger frame comprises:
a new type of trigger frame that uses a reserved value in a Trigger Type subfield encoding table to indicate that the trigger frame is used for the CSR operation; or
a variation of an existing type of trigger frame.

8. The method of claim 1, wherein the controlling of the Tx power of at least the first shared AP of the one or more shared APs comprises setting a Tx power limit or a direct Tx power level of each of the one or more shared AP based on scheduling of the one or more non-AP STAs.

9. The method of claim 1, wherein the controlling of the Tx power of at least the first shared AP of the one or more shared APs comprises assigning different power limits to at least the first shared AP per STA of the one or more non-AP STAs or per group of STAs based on one or more resource units (RUs) or multi-RUs (MRUs) corresponding to the one or more non-AP STAs.

10. The method of claim 9, wherein the controlling of the Tx power of at least the first shared AP of the one or more shared APs further comprises transmitting a trigger frame that indicates an identifier (ID) of the first shared AP, a number of RU or MRU indexes and, for each of the one or more RUs or MRUs, a respective RU or MRU index and a respective maximum Tx power.

11. The method of claim 1, wherein the assigning of the different power limits to at least the first shared AP comprises:
splitting a physical-layer protocol data unit (PPDU) bandwidth into a plurality of segments by a number of the different power limits; and
assigning each of the different power limits to a respective segment of the plurality of segments.

12. The method of claim 1, wherein the controlling of the Tx power of at least the first shared AP of the one or more shared APs comprises providing a bitmap with each bit of the bitmap indicating a respective Tx power limit or direct Tx power level corresponding to a respective frequency segment or subchannel of an operating bandwidth.

13. The method of claim 1, wherein the controlling of the Tx power of at least the first shared AP of the one or more shared APs comprises scheduling each of the one or more non-AP STAs based on a corresponding received signal strength indicator (RSSI) or path loss respective to at least the first shared AP.

14. The method of claim 1, wherein the controlling of the Tx power of at least the first shared AP of the one or more shared APs comprises causing at least the first shared AP when SU transmission by:
boosting a power spectral density (PSD) while keeping a same modulation and coding scheme (MCS); or
boosting the PSD with an independent encoding scheme and MCS level boosting; or
boosting the PSD with a joint encoding scheme and quadrature amplitude modulation (QAM) level boosting.

15. The method of claim 1, wherein the controlling of the Tx power of at least the first shared AP of the one or more shared APs comprises indicating to at least the first shared AP one or more Tx power limits and one or more CSR durations with each of the one or more Tx power limits corresponding to each of the one or more CSR durations.

16. A method, comprising:
participating, by a processor of a shared access point (AP), in a coordinated spatial reuse (CSR) operation with a sharing AP regarding communications with one or more non-AP stations (STAs) associated with the sharing AP; and
receiving, by the processor, a transmit (Tx) power signaling from the sharing AP that controls a Tx power of the shared AP in the CSR operation within a transmission opportunity (TXOP).

17. The method of claim 16, wherein the Tx power signaling controls at least one of:
a direct Tx power level or a Tx power limit of the shared AP;
a direct Tx power level or a Tx power limit for different resource units (RUs) or multi-RUs (MRUs) of the shared AP;
a direct Tx power level or a Tx power limit for predefined or selected subchannels of the shared AP; and
a direct Tx power level or a Tx power limit for a selected CSR duration of the shared AP.

18. The method of claim 16, wherein the receiving of the Tx power signaling comprises receiving a trigger frame that indicates an identifier (ID) of the shared AP and information associated to control of a Tx power of the shared AP.

19. The of claim 18, wherein the information associated to control of a Tx power of the first shared AP comprises one or more of:
a direct Tx power level or a Tx power limit of the shared AP;
a quantity of the one or more shared APs;
a number of resource units (RUs) or multi-RUs (MRUs);
an RU or MRU index;
a bitmap; and
a CSR duration.
